(19) United States
(12) Patent Application Publication
(10) Pub. No.: US 2004/0177029 A1
(43) Pub. Date: Sep. 9, 2004

(54) Computer-system for Shariah-compliant computer-aided method for securing a Shariah-compliant credit enhancement

(76) Inventors: Mohamad Lutfi Hammour, Paris (FR); Larry Kershner, Collierville, TN (US); Harvey Weiner, Bethesda, MD (US)

Correspondence Address: PETER K. TRZYNA, ESQ., P O BOX 7131, CHICAGO, IL, 60680, US

(21) Appl. No.: 10/680,474

(22) Filed: Oct. 7, 2003

Related U.S. Application Data
(60) Provisional application No. 60/416,264, filed on Oct. 7, 2002.

(51) Int. Cl. G06F 17/60

(52) U.S. Cl. 705/38

(57) ABSTRACT

A computer system and computer-aided method for securing a Shariah-compliant credit enhancement, the method including the steps of: entering a property value and a property financing amount as input to a computer; computing, from the property value and a property financing amount, a quantity of mortgage insurance coverage required to satisfy a Shariah-compliant credit enhancement; and securing a mortgage insurer's commitment to an intermediary to insure a home financing contract, wherein the intermediary is not a lender or borrower. System-provided documentation is also included.

### BACKGROUND OF THE INVENTION

A. Field of the Invention

The present invention is directed to a computerized system and method for administering a Shariah-compliant credit enhancement. More particularly, the present invention pertains to digital signal processing and computer-aided activity. For example, the present invention relates to a machine and a data processing system, methods of making and for using the machine and system, products produced thereby, manufactures, as well as data structures and articles of manufacture pertaining thereto, and all necessary intermediates of that which is discussed herein. More particularly, this invention relates to data processing having particular utility in financial fields related hereto, especially as pertains to Shariah-compliant investments such as a Shariah-compliant home financing contract. Still more particularly, the present invention can encompass generation of related documentation, inter-computer communications, networking, other computer-aided support for the financial transactions, and tracking corresponding to this type of credit enhancement.

B. Background of the Invention

Most investors will only buy home financing contracts from an originator if mortgage insurance has been placed on the home financing contract when the down payment by a home purchaser does not exceed a certain amount of the purchase price of the home property. The person or persons purchasing the home can purchase the mortgage insurance from a mortgage insurance company, and in this situation the party financing the acquisition (generally a lender) will facilitate the home purchaser's securing of the mortgage insurance. The mortgage insurer will be paid a monthly premium which is included in the buyer's monthly payment related to the financed property. The monthly payment from the buyer is collected by a servicer whose role it is to act as a collection and disbursement agent. A portion of the total monthly payment is applied to interest, principal, mortgage insurance and escrow items for real property taxes and hazard insurance. The servicer distributes the monthly payment accordingly and retains a portion of said payment for performing the service of servicer.

The lender or party arranging the financer may also obtain the mortgage insurance directly from the mortgage insurance company and pass the cost through to the buyer rather than have the buyer obtain the mortgage insurance. Where this is the case, the lender pays for the mortgage insurance and builds the cost of the mortgage insurance into the monthly interest payment that the lender receives from a servicer acting as a disbursement agent. The lender or financier may buy the insurance by paying a single premium at the time the loan is originated or may pay a monthly premium to the insurance company on the policy which is entered into at the closing of the property purchase transaction.

Computer systems for the foregoing presumably reflect the focus thereof, which is not known to encompass Shariah compliance.

### SUMMARY OF THE INVENTION

The present invention, as apparent from the specification as a whole, addresses what the inventors have discovered as a demand for Shariah-compliant financing credit enhancement. The enhancement is suitable, for example, for use with a declining balance type product such as that U.S. patent application Ser. No. 10/406,010, titled “Declining Balance Co-Ownership Financing Arrangement,” filed Apr. 3, 1003, is incorporated here by reference, especially with regard to its cooperation with the present invention.

We have devised and designed a suitable credit enhancement to give those seeking financing for home purchases the assistance that has heretofore been lacking. The credit enhancement overcomes deficiencies in prior approaches described above, and provides significant advantages to both the those seeking to own a home and those seeking to facilitate the same, all in compliance with the Shariah. However, to operate the credit enhancement effectively requires a complex and sophisticated computer system, heretofore unavailable. Indeed, with no realization of the need for such a computer system, the advances made that pertain to the computer system would seemingly have gone unimagined. To understand these advances and new uses of prior techniques requires an explanation of the credit enhancement itself. However, it is noted that the principles of the present invention are applicable to the administration of like (e.g., Shariah-compliant) products as well.

Accordingly, the present invention relates to a method of obtaining and selling to a secondary market Secondary Market Participant mortgage insurance for Shariah-compliant financing contracts, such as home financing contracts, especially those that have a “contract-to-value” ratio greater than eighty percent (each such contract may hereafter a “Contract”).

The Parties:

Originator. The Originator is a seller/servicer that has been approved by a secondary market Secondary Market Participant. One example of a secondary market participant is a Secondary Market Participant such as Freddie Mac. The Originator provides funds necessary to finance transactions with the consumer who purchases a property, e.g., along with a co-owner of the property. These funds can be provided by the Originator either directly from its own funds or through a warehouse like line with a third party.

The Originator also acts as an agent, carrying out the responsibilities of an Intermediary company (discussed below) that purchases interests in the property from co-owner, obtains mortgage insurance and sells or otherwise delivers its interest in the property to the Secondary Market Participant. (In this capacity, the Originator may be referred to herein as the “Agent.”) The Originator has no obligation to carry out any responsibilities that the intermediary may have toward obtaining mortgage insurance that may be required by the Secondary Market Participant.

The Originator also acts as a servicer of the Contracts from and after their sale to the Secondary Market Participant. (In this capacity, Originator/Financier will be referred to herein as the “Servicer.”) As the Servicer, the Originator is also be responsible to carry out the Intermediary's obligations, except the payment of the insurance premium, under any credit enhancement transaction executed by the Intermediary as required for a sale to the Secondary Market Participant. In addition to traditional servicing duties (i.e., collection of payments, customer service, escrow administration) the Originator, as servicer, is also be required to prepare, if necessary, claims to mortgage insurers on behalf of the Secondary Market Participant, as well as distribute any proceeds that result from such claims. In no circumstances, however, will the Originator be responsible for collecting money from consumers for mortgage insurance.

Intermediary. The Intermediary purchases the Contracts from the Originator. (In this capacity, the Intermediary is referred to herein as the “Buyer.”) the Intermediary also obtains an appropriate policy for mortgage insurance, for example, up-front mortgage insurance (“UFMI,” see discussion below) for each Contract from an affiliated private mortgage insurance company(ies). The affiliate insurance company(ies) and the Intermediary are controlled by the same entity, and typically would be wholly-owned subsidiaries of another parent company. The Intermediary holds a master policy of mortgage insurance with all of the affiliate insurance companies with which it deals. (In this capacity, the Intermediary is referred to herein as the “Procurer.”)

The Intermediary sells each Contract to the Secondary Market Participant. The Intermediary previously will have obtained any necessary approvals from the Secondary Market Participant to act as a seller of the Contracts. (In this capacity, the Intermediary is referred to herein as the “Seller.”) The Intermediary also obtains a Master Commitment or Master Agreement from the Secondary Market Participant to deliver the Contracts. All deliveries to the Secondary Market Participant of the Contracts are pursuant to such Master Commitment or Master Agreement.

Secondary Market Participant. The Secondary Market Participant will acquire the Contracts from the Intermediary.

Step-BV-Step Overview of a Transaction

Step 1. Origination. Each Contract is closed and funded by the Originator. The Originator is the owner-of-record of each Contract. Originator may register Contracts with a Mortgage Electronic Registry System (“MERS”) to facilitate subsequent transfers of the Contracts.

Step 2. Sale by Originator to the Intermediary. The Originator sells each Contract to the Buyer on a servicing released basis. The Originator and the Buyer can do so by entering into a Purchase and Sale Agreement in connection with this transaction, and this Purchase and Sale Agreement contains all of the representations and warranties that the Secondary Market Participant requires of a seller of the Contracts. Among the representations and warranties is a requirement that the Contracts be insurable. It is important to note, however, that the sale of such Contracts is not conditioned on the Contracts actually being insured. All Contract documents are held by the Agent for and on behalf of the Buyer. The Agent also prepares assignments in blank in the same form and with the same content as the Secondary Market Participant assignment forms to allow for the transfer of each of the Contracts. The Intermediary causes these assignments to be transferred to the Secondary Market Participant. The Agent enters into an agency agreement with regard to these and other matters described in this application. (See Agency Agreement below).

Step 3. Placement of Mortgage Insurance. The Procurer obtains an appropriate UFMI policy for each Contract. (For purposes of U.S. law, UFMI complies with all requirements of lender-paid mortgage insurance.) Preferably, each UFMI policy is single premium, rather than monthly paid, insurance. However, monthly, annual pay, or otherwise are also viable alternatives. The Procurer owns each UFMI policy and when purchased is the named insured and beneficiary.

Step 4. Delivery Commitments. Prior to a commitment by the Originator, the Originator, acting as Agent, obtains, for and on behalf of the Seller, all necessary commitments from the Secondary Market Participant to allow for the delivery of the Contracts by the Seller to the Secondary Market Participant pursuant to the Master Commitment or Master Agreement. Certain of these commitments are “best efforts” commitments, and others are mandatory delivery commitments. The Agent holds the Seller harmless for any mark-to-market losses incurred by the Seller related to these commitments, as well as all other activities undertaken by Agent on behalf of the Intermediary. (See further below.)

Step 5. Sale by the Intermediary to the Secondary Market Participant. The Seller sells each Contract to the Secondary Market Participant. This sale occurs immediately after (virtually simultaneously) with the sale of the Contract by the Originator to the Buyer (see Step 2 above). The following occurs in connection with this sale:

On a concurrent basis, the related servicing rights are transferred by the Seller to the Servicer.

The sale by the Seller to the Secondary Market Participant occurs in accordance with the delivery commitments described in Step 4 above. The Secondary Market Participant permits the Agent to fulfill all obligations of the Seller under these commitments. The Intermediary provides the Secondary Market Participant with standard industry (i.e., those used by Government Sponsored Enterprises and others) representations and warranties.

Upon conclusion of this sale, the Servicer becomes the owner and named insured on each UFMI policy. As described earlier, this means that the Originator is obligated to prepare claims on behalf of the Secondary Market Participant who becomes the beneficiary on each UFMI policy.

Upon conclusion of this sale, all sale and servicing representations and warranties between the Seller and the Secondary Market Participant terminate. As a condition of the Servicer acquiring rights, obligations and benefits of servicing, Servicer is required by the Secondary Market Participant to provide certain representations and warranties to the Secondary Market Participant regarding the origination and servicing of the Contracts (“Servicer Warranties”). These representations and warranties are similar to the ones that the Originator had as the Originator. The Seller has no continuing responsibility or liability to the Secondary Market Participant.

The Seller indemnifies the Servicer for any failure of Seller to: (a) place an UFMI policy on the Contracts in a timely manner, (b) sell the Contracts to the Secondary Market Participant in a timely manner, and (c) maintain necessary licenses and approvals with the Secondary Market Participant and applicable federal, state, or local authorities.

Step 6. Document Delivery. Upon the sale to the Secondary Market Participant, the Agent delivers the relevant Contract documents to the Secondary Market Participant for and on behalf of the Seller. The “Consumer's Obligation to Pay” (or an equivalent) is endorsed upon each transfer of the Contract. See the “Declining Balance Co-Ownership Financing Arrangement patent application Ser. No. 10/406,010, incorporated by reference. An assignment of the “Security Agreement” (or an equivalent) is prepared by the Agent in blank. As noted above, at some time, such assignments may be handled by MERS.

Step 7. Payment. The Secondary Market Participant makes payment to an account designated by the Seller. The Originator has access to the account and is able to withdraw and retain all appropriate amounts. The Intermediary has access to funds only for purposes of withdrawing funds to be used to pay the up-front PMI premium.

Consider now the Figs. and detailed discussion of a preferred embodiment discussed below.

### BRIEF DESCRIPTION OF THE DRAWINGS

FIG. 1 shows an overview of parties and communications in accordance with the present invention.

FIG. 2 shows an overview sale and delivery to a secondary market participant, under a master purchase agreement in accordance with the present invention.

FIG. 3 shows an illustration of one of a plurality of computer systems, respectively used by the participants, in accordance with the present invention.

FIG. 4 shows steps in an embodiment of the present invention.

FIG. 5 shows steps in an embodiment of the present invention.

FIG. 6 shows steps in an embodiment of the present invention.

FIG. 7 shows steps in an embodiment of the present invention.

FIG. 8 shows steps in an embodiment of the present invention.

FIG. 9 shows steps in an embodiment of the present invention.

FIG. 10 illustrates a flow chart of logic in an embodiment of the present invention.

FIG. 11 illustrates a continuation from FIG. 10 of the flow chart of logic in an embodiment of the present invention.

FIG. 12 illustrates a flow chart of logic in an embodiment of the present invention.

### DETAILED DISCUSSION OF A REPRESENTATIVE EMBODIMENT

In accordance with the present invention, there is provided a machine and a data processing system, methods of making and for using the same, products produced thereby, including documentation, articles of manufacture, as well as data structures, and all necessary intermediates. For example, not to be limiting herein, the present invention can be considered as a computer-aided method for securing a Shariah-compliant credit enhancement. The method including the steps of: entering a property value and a property financing amount as input to a computer; computing, from the property value and a property financing amount, a quantity of mortgage insurance coverage required to satisfy a Shariah-compliant credit enhancement; and securing a mortgage insurer's commitment to an intermediary to insure a home financing contract, wherein said intermediary is not a lender or borrower.

In the foregoing or other embodiments herein, the step of securing can include obtaining mortgage insurance coverage subject to a self-insurance requirement.

In the foregoing or other embodiments herein, the step of securing can include obtaining mortgage insurance for said coverage, wherein said insurance is not obtained from a non-affiliated insurance provider.

In the foregoing or other embodiments herein, the method can include the step of: issuing a signal from an originator computer to a mortgage insurance provider computer communicating an amount of mortgage insurance required for said property financing amount to be insured under a master mortgage insurance agreement between a intermediary and said insurance provider.

In the foregoing or other embodiments herein, the method can include the step of issuing a communication from an insurance company computer to an originator computer by telecommunications system, said communication indicating a commitment to insure the quantity of mortgage insurance coverage under a self-insurance requirement.

In the foregoing or other embodiments herein, the method can include the step of originating the home financing contract simultaneous with ordering mortgage insurance corresponding to said coverage.

In the foregoing or other embodiments herein, the method can include the step of signaling from an originator computer to a mortgage insurance provider computer said amount of mortgage insurance coverage required on a contract to facilitate a sale under said purchase and sale agreement.

In the foregoing or other embodiments herein, the method can be carried out with an originator placing mortgage insurance with an insurance provider for said coverage absent control from a master agreement between the originator and an insurance provider.

In the foregoing or other embodiments herein, the method can be carried out with an originator placing mortgage insurance with an insurance provider for said coverage subject to control by an agency agreement the originator and the intermediary.

In the foregoing or other embodiments herein, the method can be carried out with at least one of the steps carried out under control of a master mortgage insurance policy between a intermediary and an affiliated mortgage insurance company.

In the foregoing or other embodiments herein, the method can include the steps of: making an insurance policy for said coverage required to satisfy a Shariah-compliant credit enhancement by entering a standard insurance policy into memory of a computer; modifying the standard insurance policy responsive to a communication from the intermediary, to make the insurance policy for said coverage required to satisfy a Shariah-compliant credit enhancement; and issuing said policy for said coverage.

In the foregoing or other embodiments herein, the method can include the steps of: using a standard insurance policy for said coverage required to satisfy a Shariah-compliant credit enhancement supplemented by adding definition to said standard insurance policy; and issuing said policy in combination with said definition for said coverage.

In the foregoing or other embodiments herein, the method can include the step of: providing life of contract insurance corresponding to said coverage and priced for a single payment insurance premium paid by a intermediary.

In the foregoing or other embodiments herein, the method can include the step of: paying premium payments for life of contract insurance, corresponding to said coverage, from proceeds received by the intermediary from a sale of the home financing contract.

In the foregoing or other embodiments herein, the method can include the step of: paying premium payments for life of contract insurance, corresponding to said coverage, from a commission received by the intermediary from the originator to ensure servicing of the home financing contract after delivery of the home financing contract by the intermediary to a secondary market participant.

In the foregoing or other embodiments herein, the method can include the step of: controlling computer communication of services provided by an originator as agent for the intermediary subject to an administration agreement between the originator and the intermediary.

In the foregoing or other embodiments herein, the method can include the step of: tracking, by computer, an obligation specified in an agreement between the intermediary and a secondary market participant under which an originator is the intermediary's agent to facilitate a sale of said home financing contract to the secondary market participant.

In the foregoing or other embodiments herein, the method can include the step of: communicating a designation from the intermediary's computer to an originator's computer that the originator shall service an insurance policy corresponding to said coverage.

In the foregoing or other embodiments herein, the method can include the step of linking an originator of a financing transaction corresponding to the coverage as an agent in a transaction with a subsequent buyer of the home financing contract in a secondary market participant's computer communications with a mortgage insurance provider computer.

In the foregoing or other embodiments herein, the method can be carried out with an originator of the home financing contract acting as agent for the intermediary to carry out a sale of the home financing contract to a secondary market participant.

In the foregoing or other embodiments herein, the method can include the step of sending from an insurance provider computer to an originator's computer, by telecommunications systems, a communication reflecting that said originator is agent for the intermediary in the intermediary's commitment to insure the home financing contract pursuant to an insurance certificate.

In the foregoing or other embodiments herein, the method can include the step of generating price by which the intermediary sells the home financing contract to a secondary market participant, said price including an excess beyond an initial price for the contract effective when said home financing contract was purchased from an originator.

In the foregoing or other embodiments herein, the method can include the step of applying, with the intermediary computer, at least a portion of the excess to purchase single premium insurance.

In the foregoing or other embodiments herein, the method can include the step of tracking secondary market participation to maintain a self insurance arrangement between the intermediary and the provider.

To carry out the foregoing, it is best to utilize a computer system, as discussed below. The present invention is a computerized system and method to carey out respective aspects of the credit enhancement. The present invention involves a system aiding in performance of at least four areas of the credit enhancement, namely, 1) facilitating the credit enhancement, 2) generating and/or conveying documentation, 3) tracking and monitoring, and 4) periodic reporting.

It is noted that the system initially requires the input of several pieces of information which are stored on the appropriate computer's readable memory, for use in the foregoing. The present invention involves use of this information at the respective computer system as well as in communicating, via an electronic computer-to-computer communication mechanism, such as, for example, a modem, to another computer involved in the system as a whole. Thus, in the context of the credit enhancement involves cooperation and coordination of multiple computers, can be by secure Internet communication or otherwise.

Secondly, the present invention, in tracks and/or monitors the credit enhancement for the contemplated life of the enhancement.

Documentation is discussed in detail below, but generally the computer system is utilized in generating documentation unique to the credit enhancement of the present invention.

In connection with the above processes, the present invention will tracks performance of the credit enhancement activity. Periodic reports detailing activities of the parties are generated and distributed to quantify and summarize the activities of the parties and the credit enhancements.

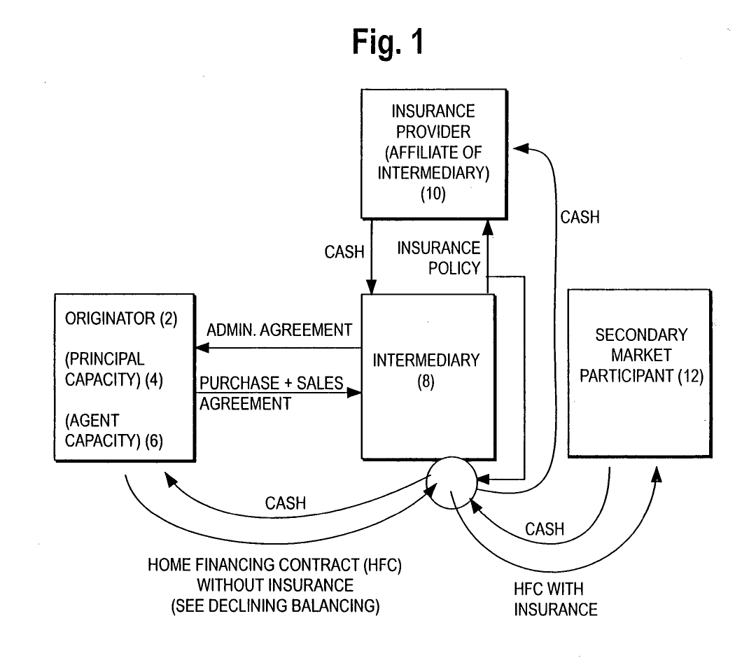

Turning now to FIG. 1 there is shown a block diagram illustrating the flow of communications between the parties to the credit enhancement arrangement. The Originator 2 funds home financing transactions whereby consumers purchase homes or refinance existing obligations on their existing home. The Originator 2 facilitates a co-owner participating in the home purchase and refinance transactions with the consumer. The origination of these transactions (home finance contracts) is performed by the Originator 2 in its role as the Principal 4. The Originator 2 enters into two written agreements with the Intermediary 8. One agreement is a Purchase & Sale Agreement (see below) in which the Originator 2 in its capacity as the Principal 4 sells the home financing contracts it has originated to the Intermediary 8. The second agreement is an Administration Agreement (see below) in which the Originator 2 in its role as the Agent 6 agrees to perform agreed to services for the Intermediary 8 and the Intermediary 8 requests and agrees to the Originator 2 performing such agreed to serves in the Agent 6 capacity. Services performed by the Originator 2 in the Agency capacity 6 are performed both before and after home financing contracts are sold by the Originator 2 in the Principal capacity 4 and after such sale to the Intermediary 8. The Intermediary 8 purchases an insurance policy from an affiliated the Insurance Provider 10 and places the insurance on the home financing contracts the Intermediary 8 has purchased from the Originator 2. The Intermediary 10, after obtaining the insurance policy from the Insurance Provider 10, sells the home financing contract with the insurance policy to the Secondary Market Participant 12 for cash. The cash received by the Intermediary 8 from the sale to the Secondary Market Participant 12 is used to pay the Insurance Provider 10 for the insurance obtained and to pay the Originator 2 in its capacity as the Principal 4 for the purchase of the home finance contract.

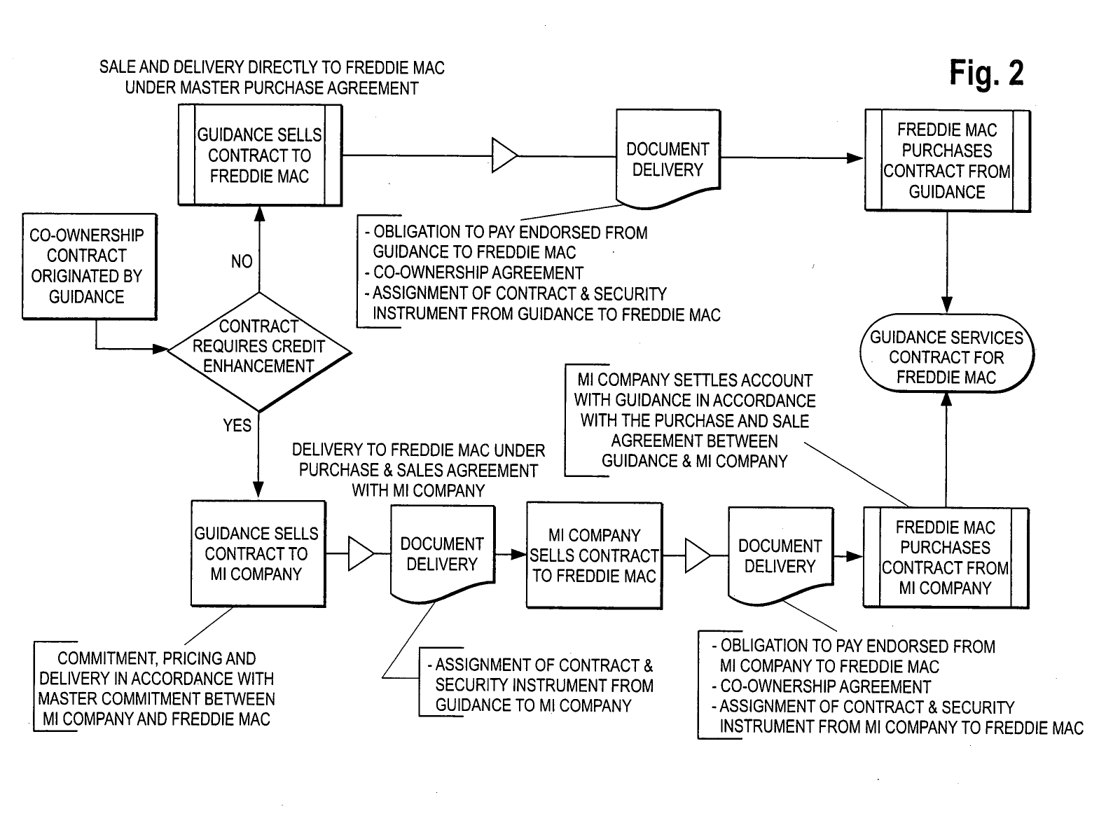

FIG. 2 is a pictorial illustration of the transaction and is labeled to be self-explanatory of the foregoing example. Arrows betweeen boxes in FIG. 2 indicate a change in possession or “ownership” of a communication.

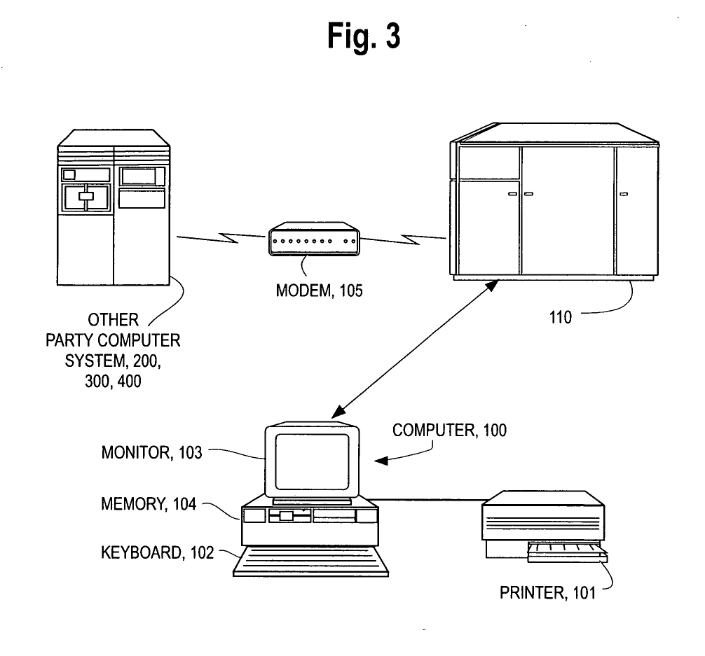

Referring now to FIG. 3, there is illustrated a representative system architecture diagram according to the present invention. Each of the parties discussed herein has a respective computer system that is illustrated in detail for one party with the understanding that another party can utilize an equivalent system. That is, a computer system 110 is represents one architecture that each of the parties hereto can utilize, such that each of the other parties have a respective computer system 200, 300, and 400, illustrated singularly in FIG. 3 with the understanding that the components elaborated in connection with computer system 110 and its items 100, 101, 102, 103, 104, and 105 find correspondence in the other parties' computers of 200, 300, and 400. Computer 110 is coupled by a computer-to-computer communication device, such as, for example, a modem 105, to the other party's computer system 200, 300, and 400.

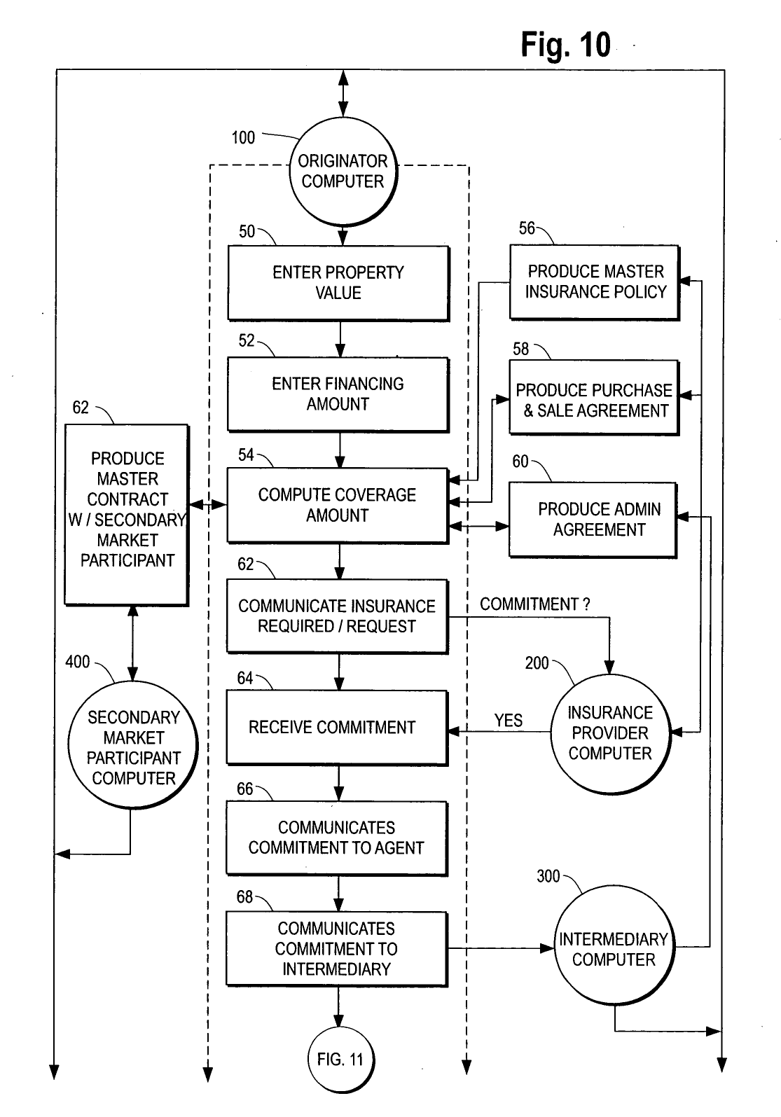

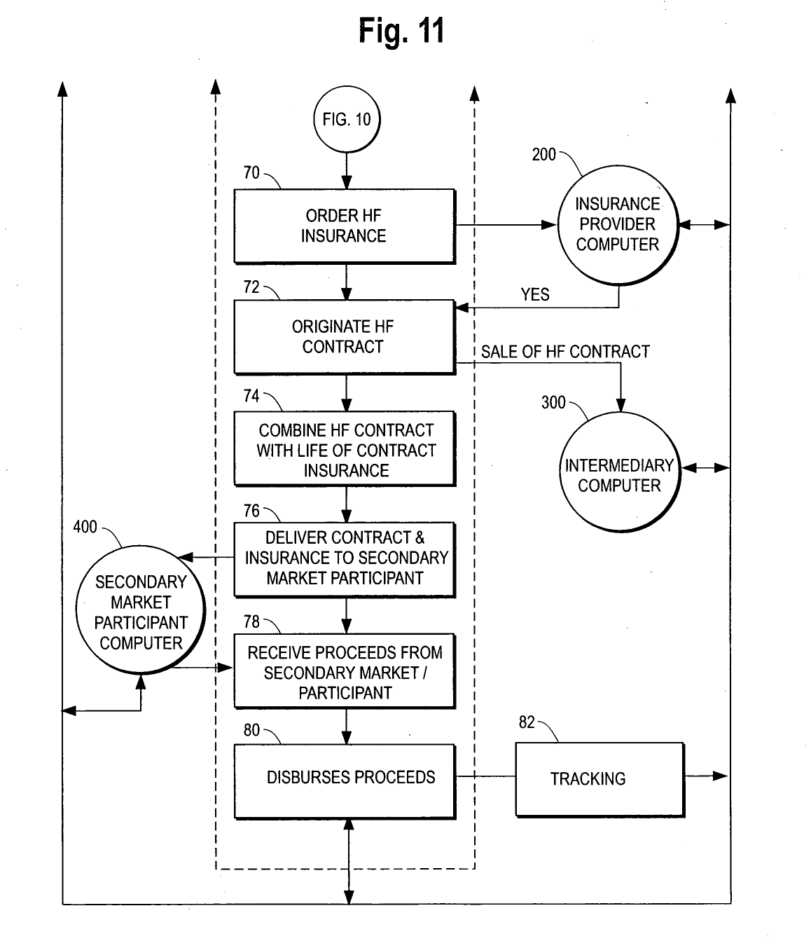

In illustrating a representative hardware configuration to participate in the structure shown in FIGS. 10-11, according to the present invention, the computer 100 is operated locally and preferably in cooperation with a network computer 110. Alternatively, a network approach is not required. The computer system 100 can be programmed for carrying out local aspects of the respective party's portion of the invention, as detailed below. The computer system 100 can also be programmed to generate required documentation and/or handle communication with the computer systems 200, 300, an 400. Typically, the computer system 100 will comprise a processor, such as an Intel PENTIUM™ processor, memory 104 (e.g., a RAM memory and a secondary memory device, such as a CD-ROM drive), input devices (such as a keyboard 102, mouse and/or trackball), and output devices (such as a monitor 103 and a printer 101). Typically, the computer system will also comprise an operating system, such as, for example, a Microsoft™, Windows, Linex, or other operating system.

The computer system 100 of the present invention has capabilities to communicate with the other parties' computer systems 200, 300, and 400, in a secure manner, including communications over the Internet, for example.

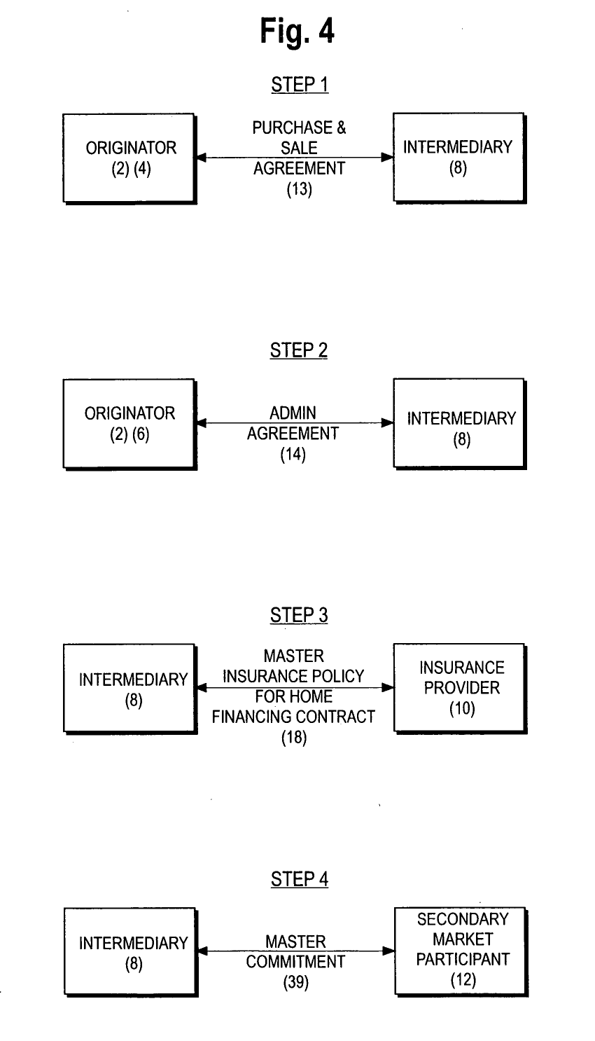

FIG. 4 is a block diagram setting forth the first four steps in securing the Shariah-compliant credit enhancement. In step 1, the Originator 2 in its capacity as the Principal 4 enters into the Purchase & Sale Agreement 13 with the Intermediary 8. The subject matter of the Purchase & Sale Agreement 13 is home financing contracts originated by the Originator 2. In step 2, the Originator 2 and the Intermediary enter into the Administration Agreement 14 whereby the Originator 2 in the Agency capacity 6 will perform services for the Intermediary 8. In step 3, the Intermediary 8 enters into a Master Insurance Policy 18 with the affiliated Insurance Provider 10. The insurable interests under the Master Insurance Policy 18 are the home financing contracts. In step 4, the Intermediary 8 and the Secondary Market Participant 12 enter into a Master Commitment 39 in which the Secondary Market Participant 12 commits to purchasing home financing contracts meeting set forth criteria from Intermediary 8.

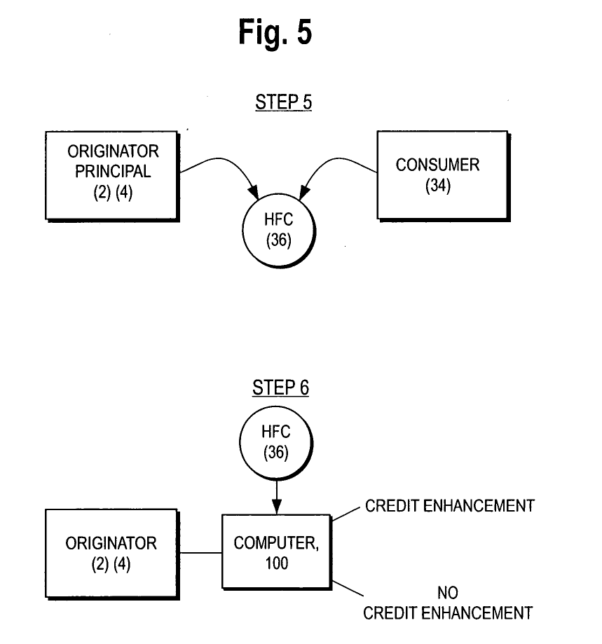

FIG. 5 contains block diagrams setting forth the fifth and sixth steps in securing the Shariah-compliant credit enhancement. In step 5, the Home Financing Contract 36 is created by the Originator 2 in its capacity as the Principal 4 and by a Consumer 34. In step 6, the Originator 2 in its capacity as Principal 4 uses its Computer 110 (e.g., 100) to determine what amount, if any, of credit enhancement is required to be obtained on the Home Finance Contract 36.

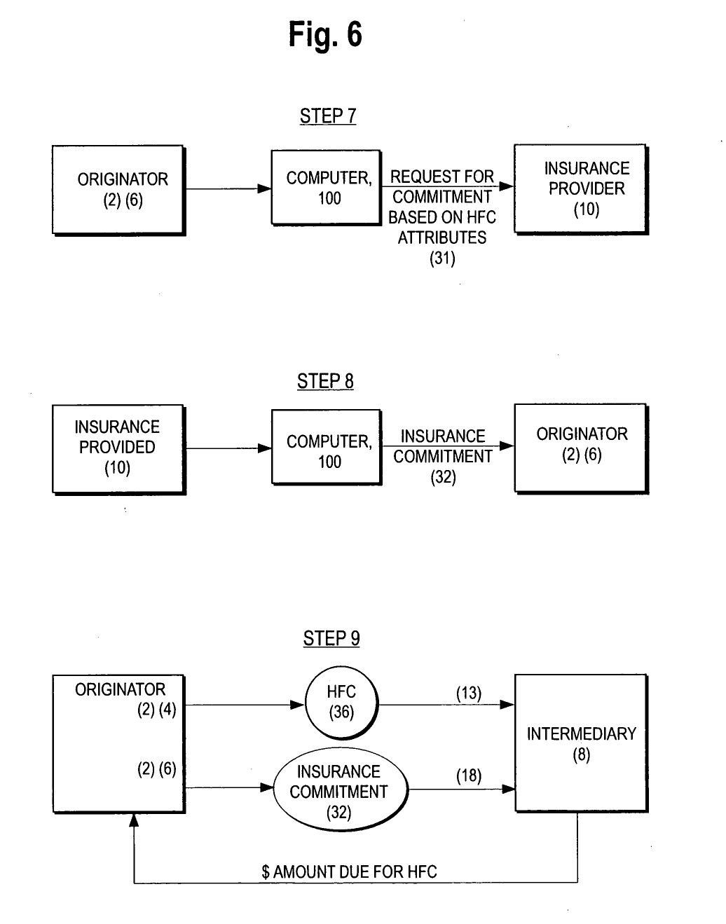

FIG. 6 continues the illustration of the steps in this process with a further block diagram setting forth the seventh, eighth, and ninth steps in securing the Shariah-compliant credit enhancement. In step 7, credit enhancement is required. The Originator 2 in its capacity as the Agent 6 for the Intermediary 8, uses its Computer 110 (e.g., 100) to Request 31 the Insurance Provider 10 signal its commitment to write insurance on the Home Finance Contract 36 under the terms of the Master Insurance Policy 18. In step 8, the Insurance Provider 10, through its computer 110, signals to Originator's computer (110) 2, with Originator 2 acting in the Agency capacity 6, the Insurance Provider's 10 insurance commitment 32 to insurance the Home Finance Contract 36 under the terms of the Master Insurance Policy 18. In step 9, the Originator 2 in its capacity as the Principal 4, sells and delivers the Home Finance Contract 36 to the Intermediary 8 under the terms of the Purchase & Sale Agreement 13. The Originator 2 in its capacity as the Agent 6, also delivers insurance commitment 32 to the Intermediary 8 that is subject to the terms of the Master Insurance Policy 18. The Originator 2 in its capacity of the Principal 4, is owed payment from the Intermediary 8 for the Home Finance Contract 36.

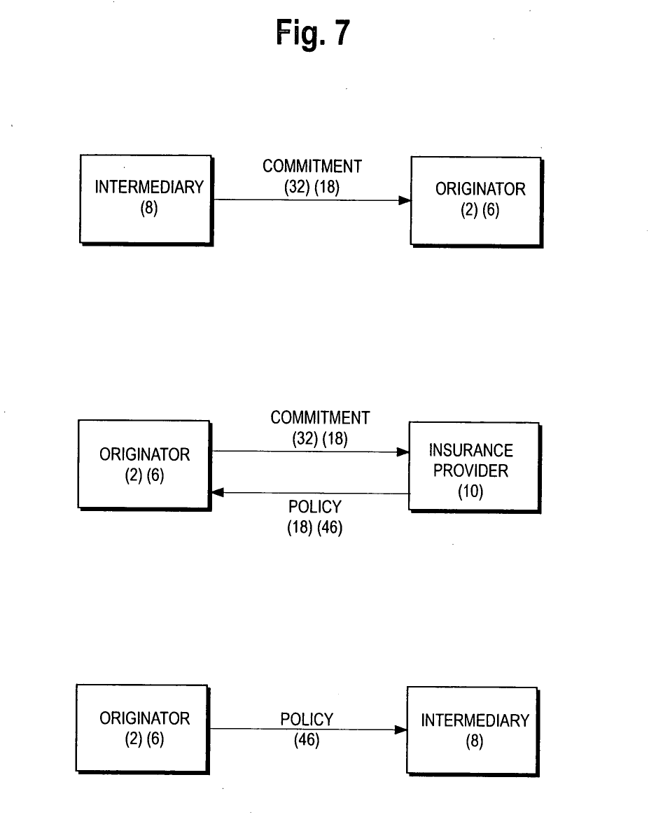

FIG. 7 is a block diagram elaborating the securing of the Shariah-compliant credit enhancement. In steps 7, 8, and 9 are highlighted as one. The Intermediary 8, through its Agent 6, the Originator 2, signals a request for the insurance commitment 32 from the Insurance Provider 10 under the terms of the Master Insurance Policy 18 and the Insurance Provider 10 signals its response 46 back to the Intermediary 8 through the Originator 2 acting as the Agent 6 for the Intermediary 8. Preferably, there is no direct contract and no direct relationship between the Originator 2 as the Principal 6 and the Insurance Provider 10.

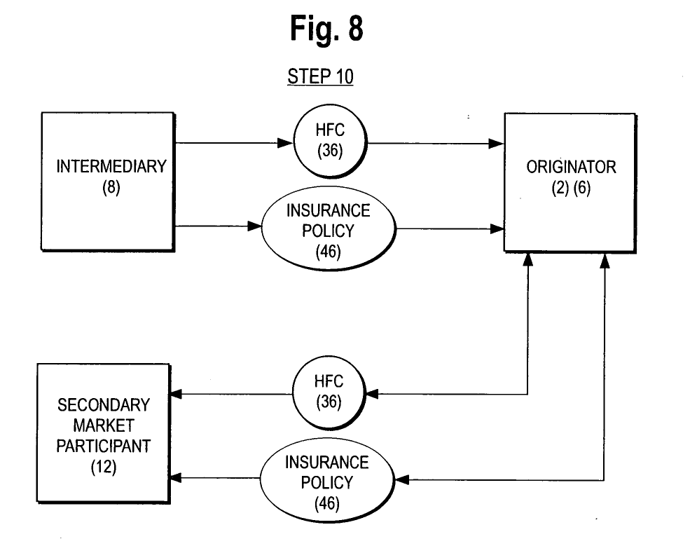

FIG. 8 is a block diagrams setting forth the tenth step in securing the Shariah-compliant credit enhancement. The Originator 2, is acting in the Agent 6 capacity, in combing and delivering the Home Finance Contract 36 and the Insurance Policy 46 to the Secondary Market Participant 12.

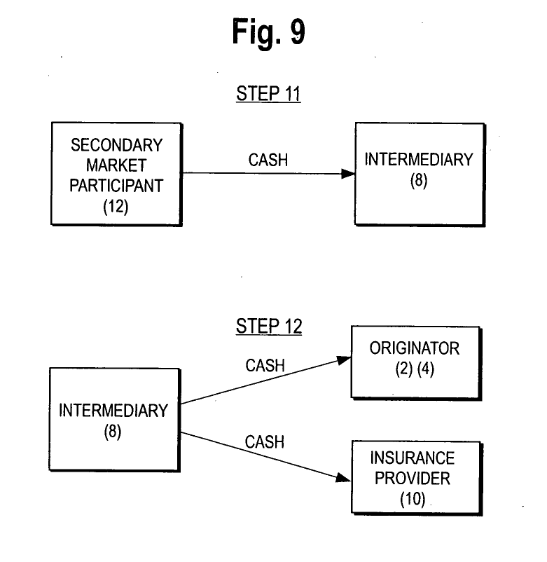

FIG. 9 is a block diagram setting forth steps eleventh and twelve in securing the Shariah-compliant credit enhancement. After receiving the Home Finance Contract 36 along with the Insurance Policy 46, the Secondary Market Participant 12 remits cash payment by way of electronic funds (e.g., wire) transfer to the Intermediary 8 pursuant to the terms of the Master Commitment 39. The Intermediary 8 remits cash to the Originator 2 to satisfy Intermediary's 8 obligation under the Purchase & Sale Agreement 13 and to the affiliated Insurance Provider 10 to pay the insurance premium on the Insurance Policy 46.

FIG. 10 sets forth a summary of the steps in using computer assistance and the flow of the overall structure when taken together with FIG. 11. In Originator's Computer 100, a property value of the Home Financing Contract 36 is entered at Block 50 along with a financing amount at Block 52. The Originator's Computer 100, computes the mortgage insurance coverage required 54. Intermediary's Computer 300, with the Originator 2 assisting in Agent capacity 6, interacts with the Insurance Provider 10 in generating at Block 56 the Master Insurance Policy 18. The Intermediary's Computer 300 and the Originator's Computer 300 interact in producing at Block 58 the Purchase & Sale Agreement 13 at Block 60, and the Administration Agreement 14. The Secondary Market Participant's Computer 400 produces at Block 62 the Master Commitment 39 committing to purchaser from the Intermediary 8. Pursuant to the terms of the Master Commitment 39, Originator's Computer 100 determines what amount of credit enhancement is required at Block 54. When credit enhancement is required, the Originator's Computer 100 signals at Block 62 to the Insurance Provider's Computer 200 and the Insurance Provider's Computer 200 indicates its willingness to insure. This signal is received at Block 64 by the Originator's Computer 100 from the Insurance Provider's Computer 200. At Block 66, the Originator 2 notes that it has acted in its Agent 6 capacity in its correspondence with the Insurance Provider 10. The Originator 2 communicates at Block 66 the Insurance Provider's commitment 32 to insure to the Intermediary's Computer 300.

FIG. 11 is a continuation of the block flow diagram illustrating use of computer assistance from FIG. 10. At Block 70, the Originator 2 orders the mortgage insurance from the Insurance Provider 10 through the Originator's Computer 100. The Originator 2 has originated the Home Finance Contract 36 at Block 72 that the Insurance Provider 10 has committed to insurance and the Home Finance Contract 36 is sold by the Originator 2 as Principal 4 to Intermediary 8. The Intermediary 8, through the Agent 6, combines at Block 74 the insurance policy 46 procured from the Insurance Provider's Computer 200 with the Home Financing Contract 36 purchased from the Originator 2 and delivers at Block 76, through the Agent 6, the Home Finance Contract 36 and the insurance policy 46 to the Secondary Market Participant 12. The proceeds from the Secondary Market Participant 12 are received at Block 78 and at Block 82 disbursements are made at Block 80. The Originator's Computer 100 tracks the activities as the Agent 6 and as the Principal 4 pursuant to the terms of the Purchase & Sale Agreement 13.

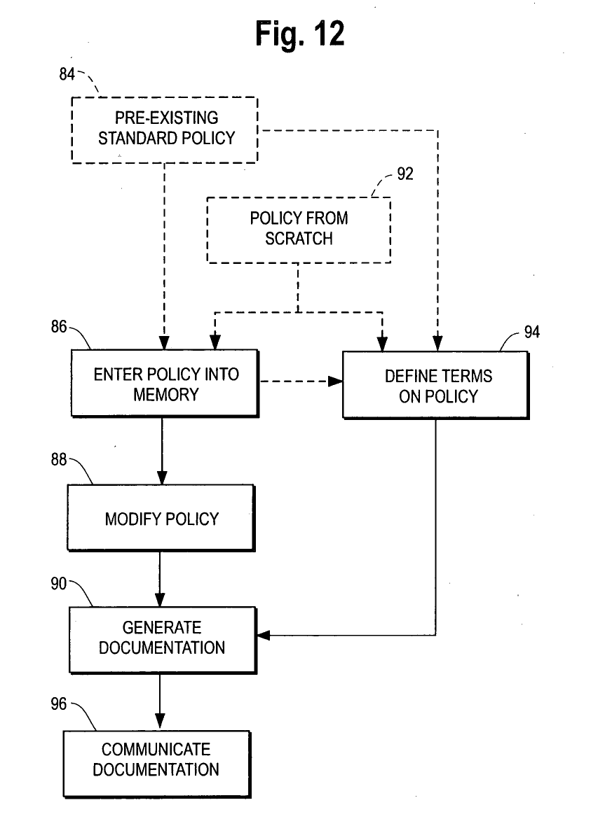

FIG. 12 is a summary of a computer-aided process for making the insurance policy 46 used in the credit enhancement. One approach is for the Insurance Provider 10 to utilize a standard Pre-existing Master Policy 84. The Insurance Provider 10 enters the Pre-existing Master Policy 84 into memory 86 of its Computer 110 and modifies this policy at Block 88 such that the Pre-existing Master Policy 84 has terms at Block 94 for the Shariah-compliant nature of the Home Financing Contract 36. This facilitates generating documentation at Block 96 for the Shariah-compliant master insurance policy 18. Alternatively, the Insurance Provider 10 may start from scratch at Block 92 in developing the master policy document 18 that incorporates the proper terms at Block 94 and substance to be Shariah-compliant, and thereafter generating the documentation at Block 90.

In either case, the documentation can be communicated at Block 96. All documentation in accordance with the present invention can be generated by these two approaches. Examples are elaborated below.

Agency Agreement

Among the interesting documents consistent with the present invention is an Agency Agreement, which may be worded in a manner such as:

The Originator performs the following duties as Agent for the Intermediary in order to facilitate the Intermediary's practice of selling to the Secondary Market Participant Contracts that the Intermediary has purchased from the Originator:

The Originator coordinates the Intermediary's negotiation of the Master Agreement and/or Master Commitment with the Secondary Market Participant under which the Intermediary sells and the Secondary Market Participant purchases the Contracts.

The Originator monitors daily and reports to the Intermediary not less than monthly remaining amounts under the Master Agreement and/or Master Commitment Contract(s).

The Originator, acting as Agent for the Intermediary, converts amounts under the Master Agreement and/or Master Commitment into cash Purchase Contracts as necessary to deliver Contracts from the Intermediary to the Secondary Market Participant.

The Originator performs all duties necessary to deliver contracts owned by the Intermediary to the Secondary Market Participant in accordance with the terms of the Master Agreement, the Master Commitment, individual Purchase Contracts and the requirements of a Secondary Market Participant Seller/Servicer Guide, collectively the Purchase Documents.

Originator performs all accounting, and reporting functions as may be required by the Intermediary and the Originator to establish and maintain adequate internal controls and financial reporting for the commitment, sale and delivery of contracts to Secondary Market Participant.

The Originator establishes and maintains depository bank accounts necessary to receive the cash settlement proceeds from the Secondary Market Participant to the Intermediary, and for the Secondary Market Participant to draft amounts from the Intermediary for billed fees associated with the INTERMEDIARY's sale of contracts to the Secondary Market Participant.

The Originator hires, trains, manages and compensates, as its employees, adequate staff to perform the functions anticipated by this Agency Agreement and required by the Purchase Documents.

The Originator performs daily a Market-to-Market of all open mandatory cash purchase contracts between the Intermediary and the Secondary Market Participant.

The Originator transfers daily a deposit(s) to a depository account designated by the Intermediary an amount equal to any negative Mark-to-Market calculated on the Intermediary's open mandatory cash purchase contracts with Secondary Market Participant.

The Originator executes on behalf of the Intermediary all assignments and endorsements of DBCOA contract documents required by the Secondary Market Participant to deliver such documents from the Intermediary to the Secondary Market Participant.

The Originator establishes and maintains all required electronic and physical records and files to document the individual purchase contracts with the Secondary Market Participant.

The Originator does not disclose the terms or existence of this Agency Agreement to any party, other than the Intermediary, unless specifically required by regulation or law.

Originator accepts from the Intermediary its obligations under its Master Agreement with the Secondary Market Participant, and makes its Seller/Servicer representations and warranties, as required by the Secondary Market Participant, concurrent with the Intermediary's sale and the Secondary Market Participant's purchase of each DBCOA contract.

Purchase and Sale Agreement

Contract Purchase and Sale Agreement

THIS CONTRACT PURCHASE AND SALE Agreement (“this Agreement”) is entered into on this day of ______, between Originator (“Company”), a residential mortgage lending company organized and existing under the laws of the State of ______ and located at ______ and Intermediary (“Buyer”), an insurance company organized and existing under the laws of the State of ______ and located at ______.

I. General Information

This Article contains important basic information about the Agreement.

1.1. Purpose of Agreement. The purpose of this Agreement is:

(a) to establish Company as an approved seller of Contracts to Buyer for resale by Buyer to Secondary Market Participant (“SMP”); and

(b) to establish the terms and conditions for the origination of those Contracts which Buyer will purchase; and

(c) to establish the terms and conditions under which Buyer will purchase Contracts; and

(d) to endeavor to conduct business between the parties in a manner not inconsistent with Islamic Shariah.

1.2. Consideration. In consideration of the purpose of this Agreement and all of the provisions and mutual promises contained in it, Company and Buyer agree to all that this Agreement contains.

1.3. Certain Definitions. Anywhere the words that appear below are used in this Agreement (whether used in singular or the plural), the following definitions shall apply. Any other capitalized words which appear herein but do not appear below shall have the meaning ascribed to them in the Definition of Key Terms.

(a) “Applicable Laws”. All federal and state laws, ordinances, rules, regulations and orders applicable to the origination, holding or servicing of Contracts by Company.

(b) “Business Day”. Any day (other than Saturdays and Sundays) that SMP is open for business.

(c) “Closed Contracts”. Contracts that Buyer purchases from Company which are owned by Company prior to such purchase and owned by Buyer after such purchase and which were previously funded or purchased by the Company.

(d) “Contract Purchase Confirmation”. A written or machine or electronically generated transmission issued by Buyer to Company in response to Company's Delivery Commitment Offer made from time to time under this Agreement and in accordance with the provisions of the Guide. Contract Purchase Confirmations shall be in the form of Exhibit 1.4(d) attached hereto or in such other form as the parties may mutually agree upon.

(e) “Contract Purchase Statement”. A written or machine or electronically-generated transmission issued by Buyer confirming the purchase of one or more Contracts and which shall evidence Buyer's ownership of such Contract or Contracts. Contract Purchase Statements shall be in the form of Exhibit 1.4(e) attached hereto or in such other form as the parties may mutually agree upon.

(f) “Consumer”. The person(s) who enters into a Transaction with the Co-Owner pursuant to a Co-Ownership Agreement and is obligated to Co-Owner, as part of its monthly payment, to make Acquisition Payments to acquire an additional ownership in the Property. Consumer includes any person(s) approved by Co-Owner or Co-Owner's Assignee to assume Consumer's rights and obligations under the Co-Ownership Agreement, the Obligation to Pay and/or the Security Instrument.

(g) “Contract”. The Co-Ownership Agreement, the Obligation to Pay, the Security Instrument, the Assignment of Agreements and Amendment of Security Instrument, and the Definition of Key Terms, which, collectively, evidence and secure the obligation of the Consumer to make monthly payments to the holder thereof under the Company's Declining Balance Co-Ownership Program.

(h) “SMP”. Any secondary market participant other than Buyer (for example, The Federal Home Loan Mortgage Corporation or Freddie Mac).

(i) “Master Commitment”. The Master Commitment, issued to Buyer from SMP, that specifies the Contract form, property and underwriting guidelines, delivery procedures and total dollar amount of Contracts the Buyer agrees to purchase during a specific period of time under the term of this Agreement.

(j) “Person”. Any individual, corporation, partnership, joint venture, association, joint-stock company, trust, limited liability company, unincorporated organization, government or any agency or political subdivision thereof.

(k) “Property”. The real estate that is subject to a Contract or, where possession or title to the property has been taken by Buyer or on Buyer's behalf, was subject to such Contract.

(l) “Shariah Advisory Board”. The group of Islamic scholars appointed or sought for review of the Contract to ensure compliance with the rules and principles of Islam which govern the practices of Muslims.

(m) “Shariah Compliant Contracts”. Contract forms reviewed and approved by the Company's Shariah Supervisory Board.

(n) “the Guides”. From time to time and collectively, SMP's Guides issued to their approved Seller/Servicers, applicable bulletins, applicable programs for the PC User's Guide, any other Purchase Documents as the latter term is defined in SMP's Guides, and modifications of the SMP's Guides.

(o) “Transaction”. The contractual obligations entered into between the Consumer, Co-Owner, and Company under the Declining Co-Ownership Program.

All other terms used but not defined herein shall have the same respective meanings as set forth in the Guides.

II. Eligibility Requirements for Company

2.1. Requirements. The following are the requirements Company must meet to be eligible to sell Contracts to Buyer:

(a) Meet Buyer's Standard. Company must have and maintain as one of its principal business purposes the origination or purchase of Contracts of the type that Company will sell to Buyer under this Agreement. In addition, Company, in Buyer's reasonable judgment, must, at all times, have the capacity to originate Contracts for Buyer that meet SMP's standards.

(b) Have Qualified Staff and Adequate Facilities and Systems. Company must, at all times, employ personnel or agents who are well trained and qualified to perform the functions required of Company under this Agreement. In addition, Company must maintain facilities and systems that are able to perform its functions under this Agreement.

2.2. Access to Company's Records. Company agrees, upon receipt of reasonable advance written notice, to permit, and cause its agents to permit, Buyer's and SMP's employees and designated representatives to examine or audit books, records and information pertaining to the Closed Contracts during normal business hours and in a manner that will not unreasonably interfere with Company's business activities.

III. Sale of Contracts

This Article contains the rules governing the origination of Contracts for sale to Buyer. Company hereby agrees as follows:

3.1. What Governs Origination. The sale of Contracts to Buyer hereunder will be governed by:

(a) this Agreement;

(b) the Guides, including, without limitation, with respect to any particular Contract, all amendments in effect on the day the Company or its designee issues a written or electronic commitment to the Consumer with respect to the making of such Contract;

(c) the applicable Master Commitment;

(d) Contract Purchase Confirmation; and

(e) Contract Purchase Statement.

3.2. What Contracts will be Purchased under this Agreement.

(a) Company will sell to Buyer, and Buyer will purchase Company's undivided ownership in, each Contract delivered to Buyer by Company under this Agreement which Company represents and warrants satisfies the requirements set forth herein and in the Guides on the day Company or its designee issues a written or electronic commitment to the Consumer with respect to the making of such Contract, provided the original amount of each Contract is greater than eighty percent (80%) of the value of the related Property, as determined in accordance with the Guides.

3.3. Master Commitment.

(a) General. Contracts will be sold to Buyer under Master Commitments. Company commits to use its best efforts to sell to Buyer Contracts satisfying the Master Commitment within the estimated period for the origination or sale of such Contracts as set forth in the applicable Master Commitment.

(b) Types of Contracts. A Master Commitment may contain only those types of Contracts which are permitted by the Guides and Company's Shariah Advisory Board.

3.4. Purchase Price. For each Closed Contract under this Agreement, the Company shall be paid a market rate purchase price (the “Purchase Price”) as agreed to by Company and the Buyer. The Purchase Price for each particular Closed Contract shall be set forth in a Contract Purchase Confirmation applicable to the Contract to be purchased, adjusted for any fees, costs or expenses incurred by Buyer, which shall include but not be limited delivery and underwriting fees.

3.5. Funding. Buyer will fund the purchase and each Contract delivered by Company concurrent with the funding from SMP.

3.6. Buyer Obligation.

(a) Buyer shall purchase all Contracts offered by Company that satisfy the requirements set forth herein.

(b) Immediately following Buyer's purchase of each Contract hereunder, Buyer shall, in accordance with the requirements of the Guides, provide or obtain an appropriate policy of mortgage guaranty insurance for each Closed Contract. The parties anticipate that each such insurance policy shall be single premium insurance but is not required to be so. Buyer shall endeavor to obtain the most advantageous Shariah compliant insurance in terms of cost and as otherwise consistent with this Agreement.

(c) Buyer shall sell all Closed Contracts to SMP with servicing transferred simultaneously upon such sale to Company.

3.7. Company's Role as Contract Originator. Company shall owe Buyer fiduciary duties in connection with the origination and sale of Closed Contracts. Company shall originate all Contracts to be sold to Buyer under this Agreement in its own name and sell its undivided ownership in such Contracts to Buyer in accordance with the Guides. Section 5.5 of this Agreement specifies certain circumstances in which Company may be obligated to repurchase a Closed Contract from Buyer. Except with regard to any Closed Contract Company is required to repurchase under Section 5.5, Company acknowledges and agrees that at no time will it or any other Person (other than Buyer, SMP, and their respective successors and assigns) have any ownership in Closed Contracts purchased under this Agreement after the sale of such Closed Contracts to Buyer. With the exception of any Closed Contracts which Company may be required to repurchase under Section 5.5, Company will take all action necessary to protect the rights of Buyer, SMP and their respective successors and assigns in the Closed Contracts against any other Person.

IV. Origination of Contracts—Company's Warranties

5.1. General. Company makes certain warranties to Buyer. These warranties:

(a) apply to each Contract sold to Buyer;

(b) are made as of (i) the date hereof (except with respect to warranties under Section 5.3), (ii) with respect to warranties under Section 5.3, the date hereof with respect to Closed Contracts originated before the date hereof, and (iii) with respect to warranties under Section 5.3, the closing date of each Closed Contract originated by Company after the date hereof;

(c) continue after the origination of the Contract, after Buyer's purchase of the Contract, and after Buyer's sale of the Closed Contract;

(d) are for the benefit of Buyer and SMP, and their respective successors and assigns; and

(e) include the warranties set forth in the Guides.

Warranties may be waived, but only by Buyer in a writing duly executed and delivered by Buyer to Company.

5.2. General Company Warranties. Company makes each of the representations and warranties set forth below regarding Company as of the date hereof and as of each day thereafter until termination of this Agreement in accordance with its terms:

(a) It is duly organized, validly existing and in good standing under the laws governing its creation and existence, and has full corporate power and authority to own its property, to carry on its business as presently conducted and to enter into and perform its obligations under this Agreement.

(b) The execution, delivery and performance by it of this Agreement have been duly authorized by all necessary action on its part. Neither the execution and delivery of this Agreement by it, nor the consummation by it of the transactions herein contemplated, nor compliance by it with the provisions hereof, will conflict with or result in a material breach of, or constitute a material default under (i) any of the provisions of any law, governmental rule, regulation, judgment, decree or order binding on it or its properties; (ii) its organizational documents or by-laws; or (iii) the terms of any material indenture or other agreement or instrument to which it is a party or by which it is bound. Neither it nor any of its affiliates is a party to, bound by, or in breach of or violation of any indenture or other agreement or instrument, or subject to or in violation of any statute, order or regulation of any court, regulatory body, administrative agency or governmental body having jurisdiction over it, which materially and adversely affects or to its knowledge may in the future materially and adversely affect its ability to perform its obligations under this Agreement or its business, operations, financial condition, properties or assets.

(c) The execution, delivery and performance by it of this Agreement and the consummation of the transaction contemplated hereby do not require the consent or approval of, the giving of notice to, the registration with, or the taking of any other action in respect of, any state, federal or other governmental authority or agency, except such as has been obtained, given, effected or taken prior to the date hereof.

(d) This Agreement has been duly executed and delivered by it and constitutes a legal, valid and binding obligation of it, enforceable against it in accordance with the terms hereof, except as such enforcement may be limited by bankruptcy, insolvency, reorganization, receivership, conservatorship, moratorium and other similar laws affecting the enforcement of creditors' rights in general and by general equity principles, regardless of whether such enforcement is considered in a proceeding in equity or at law.

(e) There are no actions, suits or proceedings pending or, to its knowledge, threatened against or affecting it, before or by any court, administrative agency, arbitrator or governmental body (i) with respect to any of the transactions contemplated by this Agreement or (ii) with respect to any other matter which in its judgment will be determined adversely to it and will, if determined adversely to it, materially and adversely affect it or its business, assets, operations or conditions (financial or otherwise) or materially and adversely affect its ability to perform its obligations under this Agreement.

(f) It has all licenses, permits, authorizations, approvals and consents of all governmental authorities required in order for it to originate or purchase, hold and sell the Contracts and in all cases, to service the Contracts.

(g) It has been and is presently approved by SMP as a Seller/Servicer.

(h) It is in compliance with all Applicable Laws.

5.3. Specific Contract Warranties. Company makes each of the following specific representations and warranties with respect to each Closed Contract and each Property as of the date set forth in Section 5.1(b):

(a) Contract Meets Requirements: The Closed Contract conforms to all of the applicable requirements in the Guides, this Agreement, and Applicable Laws.

(b) Company Authorized to Do Business: Company and any other party involved in the origination of the Closed Contract, at all applicable times:

(1) were authorized to transact business in all applicable jurisdictions, including, without limitation, the jurisdiction where the Property is located, unless at all such times, such authorization to transact business was not required, based upon the activities of Company or other relevant party, as the case may be; and

(2) possessed all licenses, permits and approvals required by all Applicable Laws, including, without limitations, all Applicable Laws of the jurisdiction where the Property is located.

(c) Company has Full Right to Sell. Company has full power and authority to sell the Closed Contract, and has duly authorized the sale of the Closed Contract. Company has not granted to any person other than Buyer any ownership in the Closed Contract or the right to originate, fund or hold the Closed Contract, or any ownership therein. In addition, Company's right, power and authority to sell the Closed Contract is not subject to any other person's ownership, consent or approval or to any agreement with any other person.

(d) Lien on Property. The Closed Contract is a valid and subsisting perfected first lien and security ownership on the Property described in it, and the Property is free and clear of all encumbrances and liens having priority over it except for liens for real estate taxes, and liens for special assessments, that are not yet due and payable.

(e) Documents are Valid and Enforceable. All documents and instruments constituting a part of the Closed Contract have been properly signed and delivered, are legal, valid and binding obligations of the persons purporting to be parties thereto, enforceable in accordance with the respective terms, subject only to bankruptcy laws, Soldiers' and Sailors' Relief Acts, laws relating to administering decedents' estates and general principles of equity.

(f) Property Not Subject to Liens. The Property is free and clear of all mechanics' liens, materialmen's liens and of other liens (whether senior to, pari passu with or subordinate to the Closed Contract). There are no rights outstanding that could result in any such liens being imposed on the Property. The warranty set forth in this subsection (f) is not made if Company furnishes Buyer with a title insurance policy in the amount and in form acceptable to Buyer and issued by a title insurance company acceptable to Buyer, that gives Buyer substantially the same protection as this warranty.

(g) Title Insurance. There is a title insurance policy, or other title evidence acceptable to Buyer, on the Property. The title insurance policy is in a current ALTA form (or other generally acceptable form) issued by a title insurance company satisfying the standards set forth in the Guides, is in an amount equal to the maximum amount of the Closed Contract and includes all title endorsements required by the Guides. The title insurance insures (or the other title evidence protects) Buyer as holding a first perfected lien against the Property.

(h) Modification or Subordination of Contract. Company has not done any of the following, except as may be necessary to reform the Closed Contract documents for the purpose of correcting or conforming such Contract documents to accurately reflect the Closed Contract transaction:

(1) materially modified or waived any provision of the Closed Contract;

(2) satisfied or canceled the Closed Contract in whole or in part;

(3) subordinated the Closed Contract in whole or in part;

(4) released the Property in whole or in part from the Closed Contract lien; or

(5) signed any release, cancellation, modification or satisfaction of the Closed Contract.

The warranties set forth in this subsection (h) are not made to the extent that any of the actions or occurrences set forth above have been done and have been expressly consented to by Buyer in a writing signed and delivered by Buyer to Company prior to Buyer's purchase of the Closed Contract.

(i) Contract in Good Standing. There is no default (or event or occurrence which, with notice or lapse of time or both, if uncured, would constitute a default) under the Closed Contract, and all of the following that have become due and payable have been paid or an escrow of funds sufficient to pay them has been established and funded and is held by Company:

(1) taxes;

(2) governmental and other assessments;

(3) insurance premiums;

(4) water, sewer and municipal charges;

(5) leasehold payments; and

(6) ground rents.

(j) Advances. Company has not made or knowingly received from others, any direct or indirect advance of funds in connection with the transaction on behalf of the Consumer except as provided in the Guides.

(k) Property Conforms to Zoning Laws. Company has no knowledge that any improvement to the Property is in violation of any applicable zoning law or regulation.

(l) Property Intact. The Property is not damaged by fire, wind or other cause of loss. There are no proceedings pending or, to the best of the Originator's knowledge, threatened, for the partial or total condemnation of the Property.

(m) Improvements. Any improvements that are included in the appraised value of the Property are totally within the Property's boundaries and building restriction lines. No improvements on adjoining Property encroach on the Property unless the Guides permit such an encroachment.

(n) Contract Not Usurious. The Closed Contract is not usurious and either meets or is exempt from all applicable usury laws or regulations.

(o) Compliance With Applicable Laws. Company has complied with all Applicable Laws.

(p) Property is Insured.

(1) A property insurance policy on the Property is in effect. It is written by an insurance company satisfying the standards set forth in the Guides, in the form required by the Guides, and provides fire and extended coverage for an amount at least equal to the amount required by the Guides.

(2) A flood insurance policy is in effect on the Property if required by the Guides.

(3) Any policy mentioned in this warranty contains a standard clause that names Buyer or Company as mortgagee.

(q) Contract is Acceptable Investment. Company knows of nothing involving the Closed Contract, the Property, the Consumer or the Consumer's credit standing that can reasonably be expected to:

(1) cause SMP to regard the Closed Contract as unacceptable for purchase from Buyer;

(2) cause the Closed Contract to become delinquent; or

(3) adversely affect the Closed Contract's value or marketability.

(r) Contract Assignments.

(1) The Obligation to Pay has been duly endorsed by Company to Buyer. Each such endorsement shall be substantially in the following form: “Pay to the order of [assignee's name], without recourse.”

(2) Company has executed and delivered to Buyer an Assignment of Agreements and Amendment of Security Instrument satisfying the requirements of the Guides.

(3) Each such endorsement and assignment has been duly authorized, executed and delivered by each applicable party to each thereof and is the legal, valid and binding obligation of such party, enforceable in accordance with its terms.

(4) The original Security Instrument was duly recorded in the appropriate real estate records where such recordation is necessary to perfect the lien thereof.

(s) Servicing Held by Company. The servicing of such Closed Contract is properly held by Company and all notices required by Applicable Laws regarding any transfer of servicing shall have been delivered to the applicable Consumer. The servicing of such Closed Contract by Company or any other servicer shall have complied with the applicable Closed Contract documents and all Applicable Laws.

(t) Title to Contract. Immediately prior to giving effect to the assignment of the Contract to Buyer, Company holds all right, title and ownership in and to the Contract, including, without limitation, all servicing rights with respect thereto, free and clear of all liens, encumbrances, participation ownerships, claims or other ownerships of any other person.

(u) Origination and Collection Practices. The origination and collection practices used by Company and any servicer of the Closed Contract have been legal, proper, prudent and customary in the industry.

(v) Proceeds Disbursed. The proceeds of the Closed Contract have been fully disbursed. All costs, fees and expenses incurred in making, closing and recording the Closed Contract have been paid in full.

(w) No Foreclosure. There is no foreclosure proceeding pending or, to the best of Company's knowledge, threatened, with respect to such Closed Contract or any Property subject thereto.

(x) Bulk Sales, Etc. No transfer of such Closed Contract by any holder thereof, including (without limitation) the transfer by Company to Buyer was or is the subject of any bulk sale law or other similar law of any jurisdiction.

5.4. Notice of Breach. Company shall promptly give Buyer notice of any breach of any representation or warranty set forth herein or incorporated herein by reference, which notice shall be in writing and shall describe in reasonable detail the nature of such breach. Company shall promptly provide to Buyer such additional information regarding any such breach as Buyer shall request.

5.5. Consequences of Untrue Warranties or Representation—Repurchase: Other Remedies.

(a) Buyer may require Company to repurchase a Closed Contract from Buyer if any warranty or representation made by Company about the Closed Contract or the related Property is untrue in any material respect (whether the warranty is in this Agreement or any of the Guides, or was made at Buyer's specific request); provided, however, that prior to Company having any obligation to repurchase a Closed Contract hereunder, Company shall have the opportunity, at Company's sole cost and expense, to cure to the reasonable satisfaction of Buyer the defect in such Closed Contract that gave rise to the repurchase obligation.

(b) Buyer may require such repurchase whether or not Company had actual knowledge of the breach of warranty or representation. Buyer may also enforce any other remedy available at law or in equity.

(c) The repurchase price to be paid by Company shall be as provided in the Guides so as to make the Buyer whole.

5.6. Consequences of Untrue Warranties or Representation—Termination of Agreement. While untrue warranties or representations of Company about a particular Closed Contract or Property may be the basis for requiring repurchase of the particular Closed Contract by Company, they may also give rise to responsibilities of Company under Section 5.7. In addition, untrue warranties or representations of Company can, under the circumstances described in Articles VIII and IX, be treated as a breach of contract that could result in the withdrawal of Buyer's approval of Company and the termination of this Agreement by Buyer.

5.7. Indemnification for Breach of Warranties or Representations; Holding Buyer Harmless. If there is a breach of warranty or representation of Company under this Agreement, Company agrees to indemnify, defend and hold Buyer and its shareholders, directors, officers, employees and agents harmless from and against any related losses, damages, claims, actions, causes of action, liabilities, obligations, judgments, penalties, fines, forfeitures, costs and expenses, including, without limitation, legal fees and expenses. Such defense shall be conducted by counsel reasonably acceptable to Buyer. Company shall have no liability for consequential damages or administrative or overhead expenses.

5.8. General Buyer Warranties. Buyer makes each of the representations and warranties set forth below regarding Buyer as of the date hereof and as of each day thereafter until termination of this Agreement in accordance with its terms:

(a) It is duly organized, validly existing and in good standing under the laws governing its creation and existence, and has full corporate power and authority to own its property, to carry on its business as presently conducted and to enter into and perform its obligations under this Agreement.

(b) The execution, delivery and performance by it of this Agreement have been duly authorized by all necessary action on its part. Neither the execution and delivery of this Agreement by it, nor the consummation by it of the transactions herein contemplated, nor compliance by it with the provisions hereof, will conflict with or result in a material breach of, or constitute a material default under (i) any of the provisions of any law, governmental rule, regulation, judgment, decree or order binding on it or its properties; (ii) its organizational documents or by-laws; or (iii) the terms of any material indenture or other agreement or instrument to which it is a party or by which it is bound. Neither it nor any of its affiliates is a party to, bound by, or in breach of or violation of any indenture or other agreement or instrument, or subject to or in violation of any statute, order or regulation of any court, regulatory body, administrative agency or governmental body having jurisdiction over it, which materially and adversely affects or to its knowledge may in the future materially and adversely affect its ability to perform its obligations under this Agreement or its business, operations, financial condition, properties or assets.

(c) The execution, delivery and performance by it of this Agreement and the consummation of the transaction contemplated hereby do not require the consent or approval of, the giving of notice to, the registration with, or the taking of any other action in respect of, any state, federal or other governmental authority or agency, except such as has been obtained, given, effected or taken prior to the date hereof.

(d) This Agreement has been duly executed and delivered by it and constitutes a legal, valid and binding obligation of it, enforceable against it in accordance with the terms hereof, except as such enforcement may be limited by bankruptcy, insolvency, reorganization, receivership, conservatorship, moratorium and other similar laws affecting the enforcement of creditors' rights in general and by general equity principles, regardless of whether such enforcement is considered in a proceeding in equity or at law.

(e) There are no actions, suits or proceedings pending or, to its knowledge, threatened against or affecting it, before or by any court, administrative agency, arbitrator or governmental body (i) with respect to any of the transactions contemplated by this Agreement or (ii) with respect to any other matter which in its judgment will be determined adversely to it and will, if determined adversely to it, materially and adversely affect it or its business, assets, operations or conditions (financial or otherwise) or materially and adversely affect its ability to perform its obligations under this Agreement.

(f) It has all licenses, permits, authorizations, approvals and consents of all governmental authorities required in order for it to purchase, hold, obtain insurance and other appropriate credit enhancements, and sell the Closed Contracts.

(g) It will be an approved SMP seller of Contracts prior to purchasing any Contract from the Company.

(h) It is in compliance with all Applicable Laws.

(i) It at all applicable times:

(1) is and was authorized to transact business in all applicable jurisdictions, including, without limitation, the jurisdiction where the Property is located, unless at all such times, such authorization to transact business was not required, based upon the activities of Buyer; and

(2) possesses or possessed all licenses, permits and approvals required by all Applicable Laws, including, without limitations, all Applicable Laws of the jurisdiction where the Property is located.

5.9. Notice of Breach. Buyer shall promptly give Company notice of any breach by Buyer of any representation or warranty set forth herein or incorporated herein by reference, which notice shall be in writing and shall describe in reasonable detail the nature of such breach. Buyer shall promptly provide to Company such additional information regarding any such breach as Company shall request.

5.10. Consequences of Untrue Warranties or Representation—Termination of Agreement. Untrue warranties or representations of Buyer may give rise to responsibilities of Buyer under Section 5.11. In addition, untrue warranties or representations of Buyer can, under the circumstances described in Articles VIII and IX, be treated as a breach of contract that could result in the termination of this Agreement by Company.

5.11. Indemnification for Breach of Warranties or Representations; Holding Company Harmless. If there is a breach of warranty or representation of Buyer under this Agreement, Buyer agrees to indemnify, defend and hold Company and its shareholders, directors, officers, employees and agents harmless from and against any related losses, damages, claims, actions, causes of action, liabilities, obligations, judgments, penalties, fines, forfeitures, costs and expenses, including, without limitation, legal fees and expenses. Such defense shall be conducted by counsel reasonably acceptable to Company. Buyer shall have no liability for consequential damages or administrative or overhead expenses.

VI. Assignment, Consideration and Continuance

This Article describes the parties' requirements covering assignment of, consideration for, and continuance of, this Agreement.

Assignment. Because the relationships created by this Agreement are personal, neither party may, without the other party's prior written approval, assign:

(a) this Agreement under any circumstances, either voluntarily or involuntarily, by operation of law, or otherwise; or

(b) its responsibility regarding the Contracts under this Agreement.

VII. Assigning Contract Servicing

Company hereby sells, transfers and assigns absolutely to Buyer, and Buyer hereby purchases and acquires, on a concurrent basis, all of Company's rights and responsibilities for servicing all of the Closed Contracts purchased by Buyer pursuant to this Agreement.

VIII. Breaches of Contract

8.1. Specific Breaches of Agreement. The following constitute breaches of this Agreement by Company:

(a) Untrue Warranties. It is a breach if Company breaches any of the warranties set forth in Section 5.2 or sells any Contract to Buyer which breaches any of the warranties described in Section 5.3.

(b) Failure to Comply with this Agreement or the Guides. It is a breach if Company does not comply with this Agreement or the Guides through any act or omission.

(c) Company's Financial Ability Impaired. It is a breach if there is a change in Company's financial status that, in Buyer's reasonable good faith opinion, materially and adversely affects Company's ability to satisfactorily sell Contracts. Changes of this type include without limitation:

(1) Company insolvency:

(2) adjudication of Company as a bankrupt;

(3) appointment of a receiver or conservator for Company; or

(4) Company's execution of a general assignment for the benefit of its creditors.

If any such change does take place:

(x) no ownership in this Agreement will be considered an asset or liability of Company or of its successors or assigns; and

(y) no ownership in this Agreement will pass by operation of law without Buyer's consent.

(d) Court Findings against Company or Principal Officers. It is a breach if:

(1) a court of competent jurisdiction finds that Company or any of its principal officers has committed an act of civil fraud; or

(2) Company or any of its principal officers is convicted of any criminal act related to Company's Contract origination, selling or servicing activities or that, in Buyer's reasonable good faith opinion, adversely affects Company's reputation or Buyer's reputation or ownerships.

(e) Reputation. It is a breach if the Company or any of its affiliated companies are under investigation or in violation of any law that in Buyer's reasonable good faith opinion, adversely affects Company's reputation.

(f) Cross-Defaults. It is a breach if any default occurs under any other agreement between (1) Company or any affiliate of Company and (2) Buyer.

(g) Notice and Cure. Notwithstanding anything in this Section 8.1 to the contrary, Buyer shall provide prompt notice to Company of any breach described in paragraphs (a) through (e) above, and thereafter Company shall have a reasonable opportunity to cure, to the reasonable satisfaction of Buyer, any such breach. If Company is able to effect such a cure, no breach under this Section 8.1 shall be deemed to have occurred.

8.2. Buyer's Rights upon Breach.

(a) If there is a breach of this Agreement by Company, Buyer will have the following rights:

(1) the right to terminate this Agreement in whole or in part in accordance with Article IX hereof; and

(2) any other rights under this Agreement or the Guides or available at law or in equity, including, without limitation, Buyer's rights to indemnification provided for in this Agreement and the Guides.

(b) Any forbearance by Buyer in exercising any of its rights will not be a waiver of any present or future right Buyer has under this Agreement to so terminate it or to revoke Buyer's approval of Company as an approved Originator.

8.3. Specific Breaches of Agreement. The following constitute breaches of this Agreement by Buyer:

(a) Untrue Warranties. It is a breach if Buyer breaches any of the warranties set forth in Section 5.8.

(b) Failure to Comply with this Agreement. It is a breach if Buyer does not comply with this Agreement through any act or omission.

(c) Buyer's Financial Ability Impaired. It is a breach if there is a change in Buyer's financial status that, in Company's reasonable good faith opinion, materially and adversely affects Buyer's ability to perform under the terms of this Agreement. Changes of this type include without limitation:

(1) Buyer insolvency:

(2) adjudication of Buyer as a bankrupt;

(3) appointment of a receiver or conservator for Buyer; or

(4) Buyer's execution of a general assignment for the benefit of its creditors.

If any such change does take place:

(x) no ownership in this Agreement will be considered an asset or liability of Buyer or of its successors or assigns; and

(y) no ownership in this Agreement will pass by operation of law without Company's consent.

(d) Court Findings against Buyer or Principal Officers. It is a breach if:

(1) a court of competent jurisdiction finds that Buyer or any of its principal officers has committed an act of civil fraud; or

(2) Buyer or any of its principal officers is convicted of any criminal act related to Buyer's activities hereunder or that, in Company's reasonable good faith opinion, adversely affects Buyer's reputation or Company's reputation or ownerships.

(e) Cross-Defaults. It is a breach if any default occurs under any other agreement between (1) Company or any affiliate of Company and (2) Buyer.

(f) Notice and Cure. Notwithstanding anything in this Section 8.3 to the contrary, Company shall provide prompt notice to Buyer of any breach described in paragraphs (a) through (e) above, and thereafter Buyer shall have a reasonable opportunity to cure, to the reasonable satisfaction of Company, any such breach. If Buyer is able to effect such a cure, no breach under this Section 8.3 shall be deemed to have occurred.

8.4. Company's Rights upon Breach.

(a) If there is a breach of this Agreement by Buyer, Company will have the following rights:

(1) the right to terminate this Agreement in whole or in part in accordance with Article IX hereof; and

(2) any other rights under this Agreement or the Guides or available at law or in equity, including, without limitation, Company's rights to indemnification provided for in this Agreement and the Guides.

(b) Any forbearance by Company in exercising any of its rights will not be a waiver of any present or future right Company has under this Agreement to so terminate it.

IX. Termination of Contract

The reasons why this Agreement may be terminated and the ways in which this may be done are outlined in this article. When the Agreement is terminated, the entire relationship between Company and Buyer shall end (with certain exceptions that are explained in this Article).

9.1. Termination With Cause by Either Party of Contract Origination Arrangements. The provisions of this Agreement covering the sale of Closed Contracts to Buyer under this Agreement may be terminated by Company upon a breach by Buyer under Section 8.4 hereof, or by Buyer upon a breach by Company under Section 8.2 hereof, by the giving of notice by the non-breaching party to the breaching party. Notice of termination may be given at any time but must conform to Article XI of this Agreement. Termination is effective immediately upon notice of termination, unless the notice specifies a later date upon which termination will be effective. Termination will not affect any outstanding written Contract Purchase Commitment for which Buyer has issued its written acceptance. However, if Company has breached this Agreement, Buyer may declare any or all outstanding Delivery Commitments and its acceptance thereof void.

9.2. Termination Without Cause by Either Party of Contract Origination Arrangements. The provisions of this Agreement covering the sale of Closed Contracts to Buyer under this Agreement may be terminated by Company or by Buyer, without cause, by the giving of notice by the terminating party to the non-terminating party. Notice of termination must be given at least one hundred eighty (180) days prior to the effective date of such termination and must conform to Article XI of this Agreement. Termination will not affect any outstanding written Contract Purchase Commitment for which Buyer has issued its written acceptance.

9.3. Rights of Termination Not Impaired. The exercise of a right of termination under any provision of this Agreement will not impair any further or future right of termination under the same or another provision.

X. Continuance of Responsibilities or Liabilities

Responsibilities or liabilities of Company that exist before termination of this Agreement will continue to exist after termination unless the party to whom such responsibility or liability is owed expressly releases the other party from any of them in writing. The foregoing shall apply whether the Agreement was terminated by Company or by Buyer.

XI. Notice

11.1. General. Whenever notice is required under this Agreement or by Applicable Law, it must be given as described in this Article. All demands, notices and communications under this Agreement shall be in writing (except as expressly provided in Section 11.2 below) and shall be delivered in person or sent through a nationally recognized overnight delivery service, addressed at the applicable party's address as set forth herein. Any such notice shall be deemed given upon the earlier of actual receipt and, in the case of notice by overnight courier, the Business Day immediately following the date so deposited with the overnight delivery service.

11.2. The Guides and Other Documents. Copies of the Guides, including, without limitation, any amendments or supplements, or any changes or pronouncements with respect thereto, may be provided to Company from time to time by Buyer, at its option, either (a) by regular mail or other means, or (b) electronically to Company.

11.3. Addresses. For the purposes of this Article XI, the addresses and facsimile numbers for Buyer and Company (and the electronic transmission information for Company) are as set forth in the Addendum attached hereto. Any change must be given in writing to the other party in accordance with the provisions of Section 11.1, but shall be effective only upon actual receipt.

11.4. Telephone and Electronic Communications. In addition to the provisions set forth in the Guides, Company hereby authorizes Buyer, from time to time without notice to Company, to record telephonic and other electronic communications of Company with Buyer.

XII. Prior Agreements

This Agreement supersedes any prior agreements between Company and Buyer that govern selling or servicing of Contracts to which this Agreement relates. However, this Article will not release Company or Buyer from any responsibility or liability under any prior agreements and understandings.

XIII. Severability and Enforcement

If any provision of this Agreement conflicts with Applicable Law, the other provisions of this Agreement that can be carried out without the conflicting provision will not be affected.

XIV. Captions

This Agreement's captions and headings are for convenience only and are not part of the Agreement.

XV. Other Parties

Company acknowledges that Buyer may and intends to enter into one or more agreements with SMP to convey ownerships in some or all of the Closed Contracts acquired under this Agreement. Nothing in this Agreement shall prohibit such agreements. Company authorizes Buyer to disclose to Investor the information used to approve Company as originator and to maintain those qualifications and any other information received by Buyer with respect to the Closed Contracts.

XVI. Miscellaneous Provisions

18.1. Amendment. All amendments to this Agreement shall be in writing duly executed and delivered by Company and Buyer provided, however, that Buyer may extend the period applicable to any Master Commitment without the written approval of Company.

18.2. Governing Law. THE PARTIES AGREE THAT THIS AGREEMENT SHALL BE CONSTRUED IN ACCORDANCE WITH AND GOVERNED BY THE SUBSTANTIVE LAWS (AND NOT THE CONFLICTS LAW) OF THE STATE OF ______APPLICABLE TO AGREEMENTS TO BE PERFORMED IN THE STATE OF ______. Any action or proceeding to enforce or interpret this Agreement shall be brought in the state or federal court for the county and state where Buyer is located, and if any basis for federal jurisdiction exists in such action or proceeding, it must be brought in the federal court for such state and county.

18.3. Intention of the Parties. It is the intention of the parties hereto that this Agreement does not create a joint venture or partnership between Company and Buyer, but rather this Agreement constitutes a contractual arrangement between the parties.

18.4. Successors and Assigns. This Agreement will inure to the benefit of and be binding upon the parties hereto and their respective successors and permitted assigns; provided, however, that the foregoing provision shall not be deemed to permit the assignment by either party of any of its rights or obligations hereunder in violation of this Agreement.

18.5 Counterparts. This Agreement may be signed in counterparts and by facsimile all of which shall be deemed original and binding.

This Agreement takes effect on the date this Agreement has been executed and delivered by both Company and Buyer.

COMPANY:

By:

BUYER:

By:

ADDENDUM

Address and Other Contact Information

Buyer:

Address:

Company:

Address:

EXHIBIT 1.4(d)

Buyer

CONTRACT PURCHASE CONFIRMATION

To: (“Company”)

Attention:

Fax Number:

Master Commitment Number:

Original Delivery Amount: $

Purchase Price: $

Schedule Number:

Delivery Date and Time:

Delivery Type:

Profit Rate:

Contract Purchase Confirmation NUMBER ASSIGNED:

The purpose of this communication is to set forth the terms and conditions of the Contract Purchase Confirmation made by the above-referenced Company to ______ (“Buyer”) pursuant to the Master Commitment between the parties hereto.

The definitions and provisions contained in Master Commitment are incorporated into this Contract Purchase Confirmation. In the event of any inconsistencies between those definitions and provisions and this Contract Purchase Confirmation, this Contract Purchase Confirmation will govern.

Buyer hereby accepts this Contract Purchase Confirmation as set forth above. Buyer will presume that the foregoing correctly sets forth the terms of this Contract Purchase Confirmation unless you notify us in writing no later than the next business day following receipt of this communication.

Please check this Contract Purchase Confirmation immediately upon receipt so that errors or discrepancies can be promptly identified and rectified.

EXHIBIT 1.4(e)

Buyer

CONTRACT PURCHASE STATEMENT

Seller:

Buyer:

Address of Property

Contract Dollar Amount:

Profit Rate:

Contract Identification Number:

Settlement Date:

Debt Credit

Contract Acquisition Balance

Purchased

Discount or Premium Paid

Total Disbursed to Seller

EXHIBIT 1.4(i)

MASTER COMMITMENT

Company: (“Buyer”)

Name:

Master Commitment Number:

Date:

Master Commitment Amount: $

Estimated Completion Date:

Estimated Number of Contracts:

The purpose of this communication is to set forth the terms and conditions of the Master Commitment made between the parties hereto.

The terms of this Master Commitment which are binding on the signatories are identified above.

This is a best efforts Master Commitment for any amounts not subject to outstanding a Contract Purchase Confirmation.

This Master Commitment Made as of: Accepted as of

Date: Date:

(Institution Name)

By: By:

(Signature) (Signature)

Name: Name:

(Typed Name of Signer) (Typed Name of Signer)

Title: Title:

By: By:

(Signature) (Signature)

Name: Name:

(Typed Name of Signer) (Typed Name of Signer)

Title: Title:

Side Letter

Intermediary

address

Re: Master Policy No.

Dear ______:

Originator is a mortgage banker that originates first lien residential financing contracts. The contracts originated by Originator use documents created pursuant to its Declining Balance Co-Ownership Program that conforms to Islamic law (also known as Shariah). It is contemplated that some of the property financing under the Declining Balance Co-Ownership contracts, after origination, will be sold (including servicing) to Intermediary. After such purchase, Intermediary as an approved Mortgage Insurance Provider Master Policy holder, will obtain mortgage guaranty insurance and resell to Secondary Market Participant. It is intended that the servicing will be transferred from Intermediary to Originator after the sale to Secondary Market Participant. Originator and Intermediary have entered into a certain Contract Purchase and Sale Agreement, as well as other agreement that sets forth the rights and obligations with respect to those parties and the property.

Intermediary has been issued an Mortgage Insurance Provider Master Policy identified as Policy No. ______ which uses traditional/conventional mortgage loan terminology. The terms in the Declining Balance Co-Ownership Program documentation do not conform to such terminology in some respects. With respect to the insurable risk and Master Policy, contracts created pursuant to the Declining Balance Co-Ownership Program are treated similar to those created in the conventional mortgage industry. It is deemed inappropriate and unnecessary to modify Mortgage Insurance Provider's Master Policy text; however, in order to clarify these considerations, Mortgage Insurance Provider shall treat the terms in the Declining Balance Co-Ownership Program documents set-forth below as follows for purposes of the Master Policy:

| DB Co-Ownership | Master Policy |
|---|---|
| 1. Consumer | Borrower |
| 2. Acquisition Payment | principal |
| 3. Profit Payment rate | interest rate |
| 4. Buyout Amount | unpaid principal balance |

The Master Policy will be interpreted in a manner that seeks to accommodate its use with respect to the Declining Co-Ownership Program (or “Loan” as referred to in the Master Policy). The foregoing is intended to clarify the operation and effect of the Master Policy as it relates to “Shariah contracts” insured by Mortgage Insurance Provider, but in all other respects, the terms and conditions of the Master Policy shall govern the respective insured losses.

I trust that this letter clarifies this matter to your satisfaction. Please contact us if you have any questions.

Very truly yours,

Mortgage Insurance Provider

While a particular embodiment of the present invention has been disclosed, it is to be understood that various different modifications are possible and are within the true spirit of the invention. Accordingly, other computerized aspects of the foregoing example are intended as an illustration with the understanding that these can be modified in accordance with the broad purposes of the invention. Understanding that there is no intention of limiting the present invention to the particular example and details presented herein as a teaching of one embodiment of the invention, the scope of protection for the present invention is to be determined with reference to the claims.

1. A computer-aided method for securing a Shariah-compliant credit enhancement, the method including the steps of:
entering a property value and a property financing amount as input to a computer;
computing, from the property value and a property financing amount, a quantity of mortgage insurance coverage required to satisfy a Shariah-compliant credit enhancement; and
securing a mortgage insurer's commitment to an intermediary to insure a home financing contract, wherein said intermediary is not a lender or borrower.

2. The method of claim 1, wherein the step of securing includes:
obtaining mortgage insurance coverage subject to a self-insurance requirement.

3. The method of claim 1, wherein the step of securing includes:
obtaining mortgage insurance for said coverage, wherein said insurance is not obtained from a non-affiliated insurance provider.

4. The method of claim 1, further including the step of:
issuing a signal from an originator computer to a mortgage insurance provider computer communicating an amount of mortgage insurance required for said property financing amount to be insured under a master mortgage insurance agreement between a intermediary and said insurance provider.

5. The method of claim 1, further including the step of:
issuing a communication from an insurance company computer to an originator computer by telecommunications system, said communication indicating a commitment to insure the quantity of mortgage insurance coverage under a self-insurance requirement.

6. The method of claim 5, further including the step of:
originating the home financing contract simultaneous with ordering mortgage insurance corresponding to said coverage.

7. The method of claim 6, further including the step of:
signaling from an originator computer to a mortgage insurance provider computer said amount of mortgage insurance coverage required on a contract to facilitate a sale under said purchase and sale agreement.

8. The method of claim 1, wherein said steps are carried out with an originator placing mortgage insurance with an insurance provider for said coverage absent control from a master agreement between the originator and an insurance provider.

9. The method of claim 1, wherein said steps are carried out with an originator placing mortgage insurance with an insurance provider for said coverage subject to control by an agency agreement the originator and the intermediary.

10. The method of claim 1, wherein at least one of said steps are carried out under control of a master mortgage insurance policy between a intermediary and an affiliated mortgage insurance company.

11. The method of claim 1, further including the steps of:
making an insurance policy for said coverage required to satisfy a Shariah-compliant credit enhancement by entering a standard insurance policy into memory of a computer;
modifying the standard insurance policy responsive to a communication from the intermediary, to make the insurance policy for said coverage required to satisfy a Shariah-compliant credit enhancement; and
issuing said policy for said coverage.

12. The method of claim 1, further including the steps of:
using a standard insurance policy for said coverage required to satisfy a Shariah-compliant credit enhancement supplemented by adding definition to said standard insurance policy; and
issuing said policy in combination with said definition for said coverage.

13. The method of claim 1, further including the step of:
providing life of contract insurance corresponding to said coverage and priced for a single payment insurance premium paid by a intermediary.

14. The method of claim 1, further including the step of:
paying premium payments for life of contract insurance, corresponding to said coverage, from proceeds received by the intermediary from a sale of the home financing contract.

15. The method of claim 1, further including the step of:
paying premium payments for life of contract insurance, corresponding to said coverage, from a commission received by the intermediary from the originator to ensure servicing of the home financing contract after delivery of the home financing contract by the intermediary to a secondary market participant.

16. The method of claim 1, further including the step of:
controlling computer communication of services provided by an originator as agent for the intermediary subject to an administration agreement between the originator and the intermediary.

17. The method of claim 1, further including the step of:
tracking, by computer, an obligation specified in an agreement between the intermediary and a secondary market participant under which an originator is the intermediary's agent to facilitate a sale of said home financing contract to the secondary market participant.

18. The method of claim 1, further including the step of:
communicating a designation from the intermediary's computer to an originator's computer that the originator shall service an insurance policy corresponding to said coverage.

19. The method of claim 1, further including the step of:
linking an originator of a financing transaction corresponding to the coverage as an agent in a transaction with a subsequent buyer of the home financing contract in a secondary market participant's computer communications with a mortgage insurance provider computer.

20. The method of claim 1, further including the step of an originator of the home financing contract acting as agent for the intermediary to carry out a sale of the home financing contract to a secondary market participant.

21. The method of claim 1, further including the step of:
sending from an insurance provider computer to an originator's computer, by telecommunications systems, a communication reflecting that said originator is agent for the intermediary in the intermediary's commitment to insure the home financing contract pursuant to an insurance certificate.

22. The method of claim 1, further including the step of:
generating price by which the intermediary sells the home financing contract to a secondary market participant, said price including an excess beyond an initial price for the contract effective when said home financing contract was purchased from an originator.

23. The method of claim 22, further including the step of:
applying, with the intermediary computer, at least a portion of the excess to purchase single premium insurance.

24. The method of claim 14, further including the step of:
generating price by which the intermediary sells the home financing contract to a secondary market participant, said price including an excess beyond an initial price for the contract effective when said home financing contract was purchased from an originator.

25. The method of claim 24, further including the step of:
applying, with the intermediary computer, at least a portion of the excess to purchase single premium insurance.

26. The method of claim 1, further including the step of:
tracking secondary market participation to maintain a self insurance arrangement between the intermediary and the provider.
